(19) United States
(12) Patent Application Publication
(10) Pub. No.: US 2004/0184890 A1
(43) Pub. Date: Sep. 23, 2004

(54) FLUID TRANSPORT SYSTEM WITH VIBRATORS

(76) Inventor: Shin-Tong Wu, Nan-Tou Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,146

(22) Filed: Mar. 19, 2003

(51) Int. Cl. B65G 53/40

(52) U.S. Cl. 406/75

(57) ABSTRACT

A fluid transport system with vibrators. The transport system includes a drainpipe, a feed inlet, a water inlet, at least a vibrator, and a plurality of cushions. When a highly viscous fluid transport is performed, the vibrator provides an appropriate degree of vibration to prevent the drainpipe from coating and blocking the drainpipe. The cushions are used to contain the vibration energy and to prevent the vibration from being transmitted to other devices.

### BACKGROUND OF INVENTION

1. Field of the Prior Art

The present invention relates to a fluid transport system, and more particularly, to a high viscous fluid transport system with vibrators.

2. Description of the Prior Art

In modern industrial manufacturing process, it is common to transport high viscous fluids such as slurry or silica. These high viscous fluids are apt to adhere to an inner wall of a drainpipe and block the drainpipe because of its high viscosity. In this case the drainpipe needs cleaning or replacing regularly. The replacement of the drainpipe not only increases the cost, but also the manufacturing process is stopped during the replacement period, and that affects the manufacturing efficiency.

Please refer to FIG. 1. FIG. 1 is a schematic diagram of a fluid transport system 10 of the prior art. As shown in FIG. 1, the fluid transport system 10 includes a drainpipe 12 for transporting a high viscous fluid, a plurality of bases 14 located below the drainpipe 12 for supporting the drainpipe 12, at least a feed inlet 16 installed in the drainpipe 12 for implanting the high viscous fluid into the drainpipe 12, at least a water inlet 18 for implanting water into the drainpipe 12 to increase the fluidity of the highly viscous fluid feed, and at least a pressurized nozzle 20 installed inside the drainpipe 12 to prevent the highly viscous fluid from coating on the inner wall of the drainpipe 12.

The operating processes of the fluid transport system 10 of the prior art are described as follows: a high viscous fluid feed is introduced into the drainpipe 12 via the feed inlet 16, and water is implanted into the drainpipe 12 via the water inlet 18 for increasing the fluidity of the highly viscous fluid feed. At the same time a pressurized spout is discharged by a pressurized nozzle 20 installed inside the drainpipe 12 to avoid coating of the high viscous fluid on the inner wall of the drainpipe 12.

Restricted by the facility of the factory and the installation of other manufacturing devices, however, the inclined angle of the drainpipe of the prior art is not usually large enough, so that the flow rate of the highly viscous fluid feed is too slow. This makes a high level of the fluid feed stay inside the drainpipe, meaning that the pressurized spout is used in vain because the spout cannot reach the inner wall of the drainpipe. In this case the drainpipe needs cleaning or replacing regularly, which increases the cost and stops the manufacturing process. Therefore the coating of the fluid transport system is a problem to be solved.

### SUMMARY OF INVENTION

It is therefore a primary objective of the claimed invention to provide a transport system for highly viscous fluid to solve the above-mentioned coating problem in the prior art.

In a preferred embodiment of the present invention, the highly viscous fluid transport system comprises a drainpipe for transporting a highly viscous fluid feed, at least a feed inlet for implanting the highly viscous fluid feed into the drainpipe, at least a water inlet for implanting water to increase the fluidity of the highly viscous fluid feed, at least a vibrator for providing an appropriate degree of vibration to the drainpipe and preventing the highly viscous fluid feed from coating on an inner wall of the drainpipe, and a plurality of cushions for supporting the drainpipe, containing the vibration energy, and preventing the vibration from being transmitted to other devices.

It is an advantage of the claimed invention that the fluid transport system with vibrators can prevent the highly viscous fluid feed from coating on an inner wall of the drainpipe, reduce the cleaning and replacing cost, and further increase the efficiency of the transport system.

These and other objectives of the present invention will no doubt become obvious to those of ordinary skill in the art after having read the following detailed description of the preferred embodiment that is illustrated in the various figures and drawings.

### BRIEF DESCRIPTION OF DRAWINGS

FIG. 1 is a schematic diagram of a fluid transport system of the prior art.

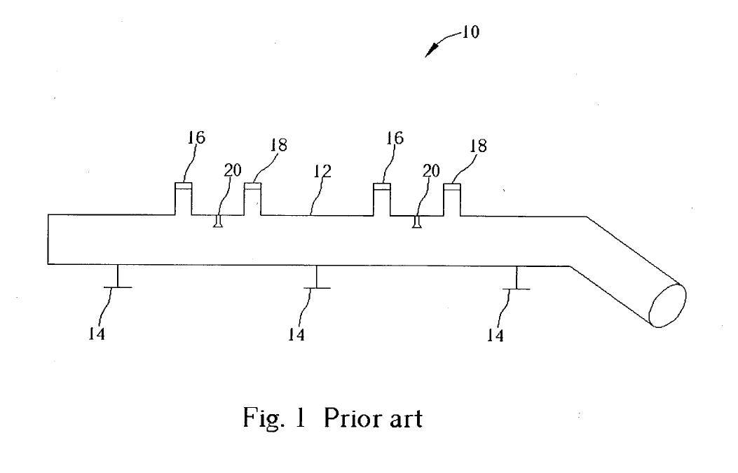

FIG. 2 is a schematic diagram of a fluid transport system of the present invention.

### DETAILED DESCRIPTION

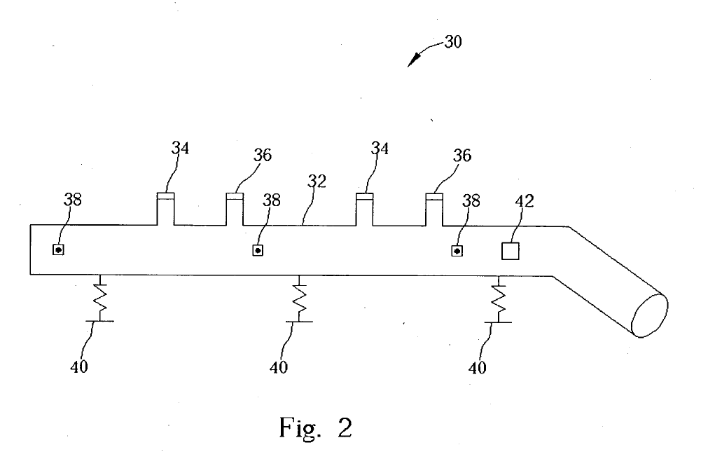

Please refer to FIG. 2. FIG. 2 is a schematic diagram of a fluid transport system 30 of the present invention. In this embodiment, the fluid transport system 30 is applied to a chemical mechanical polishing (CMP) process of semiconductor industries for transporting highly viscous fluid such as CMP slurry. However, the fluid transport system 30 is not limited to the CMP process, it can be applied to different highly viscous fluids in any other processes. As shown in FIG. 2, the fluid transport system 30 includes a drainpipe 32 for transporting a highly viscous fluid feed, at least a feed inlet 34 installed in the drainpipe 32 for implanting the highly viscous fluid feed into the drainpipe 32, at least a water inlet 36 installed in the drainpipe 32 for implanting water to increase the fluidity of the highly viscous fluid feed, at least a vibrator 38 installed on an outer wall of the drainpipe 32 for providing an appropriate degree of vibration to the drainpipe 32 and preventing the highly viscous fluid feed from coating on an inner wall of the drainpipe 32, and a plurality of cushions 40 installed below the drainpipe 32 for supporting and suspending the drainpipe 32 above ground, and further containing the vibration energy and preventing the vibration from being transmitted to other devices.

In a preferred embodiment of the present invention, the vibrator 38 is a pneumatic vibrator attached to an outer wall of the drainpipe 32, and an observation window 42 can be installed in the drainpipe 32 for observing the fluidity of the highly viscous fluid feed in the drainpipe 32.

The operating processes of the fluid transport system 30 of the present invention are described as follows: a highly viscous fluid feed containing silica generated in a CMP process is implanted into the drainpipe 32 via the feed inlet 34, and water is implanted into the drainpipe 32 via the water inlet 36 for increasing the fluidity of the highly viscous fluid feed. At the same time an appropriate degree of vibration is provided by vibrators 38 for preventing the highly viscous fluid feed from coating on an inner wall of the drainpipe 32, and the cushions 40 are used to contain the vibration energy and prevent the vibration energy from being transmitted to other devices.

In contrast to the fluid transport system of the prior art, the present invention discloses a fluid transport system with vibrators. The vibration effect can prevent the highly viscous fluid feed from coating on the inner wall of the drainpipe during transporting, and further reduce the cleaning and replacing cost so that the above-mentioned problem can be solved.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A slurry transport system comprising:
a drainpipe for receiving and transporting a slurry feed;
at least a feed inlet installed in the drainpipe for implanting the slurry feed into the drainpipe;
at least a water inlet for implanting water into the drainpipe for making the slurry flowing;
at least a vibrator installed in the drainpipe for generating proper vibration effects; and
a plurality of cushions located below the drainpipe for supporting the drainpipe;
wherein the vibrator provides an appropriate degree of vibration so that the slurry will not adhere to an inner wall of the drainpipe, and the cushions are used to contain the vibration energy and to prevent the vibration from being transmitted to other devices.

2. The slurry transport system of claim 1 wherein the slurry is from a chemical mechanical polishing (CMP) process.

3. The slurry transport system of claim 1 wherein the slurry is a highly viscous liquid.

4. The slurry transport system of claim 1 wherein the slurry contains SiO₂.

5. The slurry transport system of claim 1 wherein the vibrator is a pneumatic vibrator.

6. The slurry transport system of claim 1 wherein the vibrator is attached to a shell of the drainpipe.

7. The slurry transport system of claim 1 wherein the drainpipe is suspended above ground by the cushions.

8. The slurry transport system of claim 1 wherein an observation window is installed in the drainpipe for observing the fluidity of the slurry in the drainpipe.

9. A highly viscous fluid transport system comprising:
a drainpipe for receiving and transporting a highly viscous fluid;
at least a feed inlet for implanting the highly viscous fluid;
at least a water inlet for implanting water into the drainpipe for increasing the fluidity of the highly viscous fluid;
at least a vibrator installed in the drainpipe for generating proper vibration effects; and
a plurality of cushions located below the drainpipe for supporting the drainpipe;
wherein the vibrator provides an appropriate degree of vibration so that the highly viscous fluid will not adhere to an inner wall of the drainpipe, and the cushions are used to contain the vibration energy and to prevent the vibration from being transmitted to other devices.

10. The fluid transport system of claim 9 wherein the vibrator is a pneumatic vibrator.

11. The fluid transport system of claim 9 wherein the vibrator is attached to the drainpipe.

12. The fluid transport system of claim 9 wherein the drainpipe is suspended above ground by the cushions.

13. The fluid transport system of claim 9 wherein an observation window is installed in the drainpipe for observing the fluidity of the highly viscous fluid in the drainpipe.
